(19) United States
(12) Patent Application Publication
(10) Pub. No.: US 2017/0046929 A1
(43) Pub. Date: Feb. 16, 2017

(54) ELECTRONIC VISUAL INDICATOR SYSTEM, APPARATUS AND METHOD

(71) Applicants: Willard Strom, Mundelein, IL (US); Spencer Strom, Mundelein, IL (US)

(72) Inventors: Willard Strom, Mundelein, IL (US); Spencer Strom, Mundelein, IL (US)

(21) Appl. No.: 15/237,231

(22) Filed: Aug. 15, 2016

Related U.S. Application Data
(60) Provisional application No. 62/205,063, filed on Aug. 14, 2015.

(51) Int. Cl. G08B 5/36; G06F 1/18; G06K 7/10; H04L 29/06

(52) U.S. Cl. CPC G08B 5/36; H04L 67/42; G06F 1/182; G06K 7/10366

(57) ABSTRACT

The present disclosure relates to a system, apparatus and method for an electronic visual indicator device for indicating the status of a license registration for an object requiring registration. For example, the present disclosure relates to an electronic visual indicator device for indicating the status of a license registration for a motorized vehicle, while providing a paperless option for renewal of the vehicle registration. The present system, apparatus and method may also be useful for any other item or object requiring a registration including, but not limited to, boats, ATVs, snowmobiles, aircraft, guns, fishing poles, hunting licenses, fishing licenses, vending machines, slot machines and other items.

This application claims priority to U.S. Provisional Application Ser. No. 62/205,063 filed Aug. 14, 2015, which is incorporated herein in its entirety.

### TECHNICAL FIELD

The present disclosure relates to systems, apparatus and methods for providing visual notice, status and reminders concerning license registration and renewal of a vehicle and other items requiring a registration and/or renewal. More specifically, a system and apparatus is provided including an electronic visual indicator device for indicating the status of a registration for a motorized vehicle, while providing a paperless option for renewal of vehicle registration. The present system, apparatus and method may also be useful for others items or objects requiring a license registration and renewal including, but not limited to, boats, aircraft, guns, fishing poles, vending machines and slot machines. The present disclosure further includes a method of renewing license and registration information using a mobile application software (“app”) for use on a mobile electronic device connected through a data communication system (Internet) to a database of an appropriate government agency.

### BACKGROUND

Passenger and commercial motorized vehicles, including passenger cars, motorcycles, and both personal and commercial trucks, RVs and trailers must have a license plate and be registered for use on public roads by the appropriate agency. Some vehicles used on private property, such as tractors and off road, all-terrain vehicles (ATV), may or may not require registration. Even RVs, boats and other water vehicles may require a license or registration, depending on state requirements, which is typically obtained through the Department of Natural Resources.

Vehicle registration is usually a compulsory registration of a vehicle with a government authority. Vehicle registration requirements vary from state to state, but are typically managed by the Department of Motor Vehicles (DMV) or another agency, such as the Secretary of State, if one does not exist for the particular state.

The purpose of vehicle registration is to establish clear ownership and status of a vehicle, as well as to tax motorists or vehicle owners. While almost all vehicles are uniquely identified by a vehicle identification number, only registered vehicles display a vehicle registration sticker and carry a vehicle registration certificate.

Vehicle owners are generally required to renew their registration every year. Renewal typically involves obtaining a new vehicle registration sticker through the state's DMV or secretary of state, which is attached to the existing license plate for a vehicle. The stickers are usually issued in a different color for each year, and display the year that the registration extends to, therefore indicating when the next due date is for registration. Vehicle owners failing to renew registrations can be ticketed and fined. Law enforcement can determine if a vehicle registration is expired based on the particular color of the sticker and the month and year displayed on the sticker.

Vehicle registrations and renewals are tedious and expensive for both the vehicle owner and the DMV. The local DMV, even with a large staff, is often overwhelmed with performing its required duties, including driving tests, vehicle inspections, as well as, issuing license registrations and renewals. Existing vehicle registration systems are paper intense, requiring mailing of registration reminders, printing stickers and registration cards, as well, as requiring the vehicle owner to carry a vehicle registration card (which can be easily misplaced or destroyed) in the associated vehicle.

In today's economy, many state governments are faced with a budget crisis, and many government departments are being required to cut-back on expenses. Typically, mailing out reminders to motorists of their upcoming vehicle registration and renewal is not only paper intensive and time-consuming but expensive. Thus, there are some states, which are considering cutting back or completely ceasing mailing registration renewal reminders to state motorist, and alternatively encourage motorist to sign up for reminders received through electronic mail. However, not everyone has email or access to the internet or checks email on a regular basis. Additionally, some consumers are overwhelmed by the volume of email (including spam and junk mail) received on a regular basis, and may easily overlook a reminder. Thus an email reminder of a registration renewal may not be a solution for everyone.

Even with a mailed paper reminder, many vehicle owners often fail to remember that their registration is expiring, leaving the vehicle owner in a situation where he/she needs to obtain a renewal sticker on an expedited basis. In some cases, desperate vehicle owners may attempt to change the information on the registration sticker, in an effort to buy additional time to obtain a proper renewal. In the worst case, license plates and/or vehicle stickers may be stolen.

In addition to passenger vehicles, there are various other items and objects that require a license and registration, some on an annual basis. Trailers, both commercial and personal, RVs, boats, airplanes, ATVs, are all examples of items requiring license registrations and renewals. Hunting and fishing licenses require renewals, and guns require registration. Even vending machines and casino slot machines require registration and renewals. The present disclosure would be useful to provide a quick, efficient and economical means to maintain and renew required licenses and registrations for a variety of items.

A need exists for improved systems, apparatus and methods for obtaining registration status and renewals for a variety of objects, including passenger, commercial, air and water motorized vehicles. Specifically, a need exists for improved systems and methods that permit a faster, more efficient and economical manner of obtaining a registration renewal, as well as indicating the current status of a vehicle license and registration using a visual indicator system.

A further need exists for providing a paperless license and registration system and renewal for various items, including hunting and fishing licenses, boats, ATVs, aircraft, slot machines, vending machines and other items requiring a license and/or registration.

A further need exists for providing a paperless license renewal and registration system, while providing more accurate information concerning a specific vehicle and its registration status.

A further need exists for providing a more environmentally-friendly license renewal and registration system, while providing more accurate information concerning a specific vehicle and its registration status.

Further, a need exists for a method of renewing license and registration information using mobile application software for use on a portable or personal electronic device connected through a data communication system to a database of an appropriate government agency.

Moreover, a need exists for improved systems, apparatus and methods for reminding vehicle owners that their vehicle registrations are due for renewal.

Additionally, a need exists for improved systems, apparatus and methods to preventing forgery of registration renewal stickers.

A further need exists for improved systems, apparatus and methods for easily alerting law enforcement to an expired vehicle or other object registration. Additionally, the present system, apparatus and method may also be useful for indicating that a particular vehicle or item is stolen and/or potentially involved in illegal activity.

### SUMMARY

The present disclosure relates to systems, apparatus and methods for providing visual notice, status indicators, and reminders concerning license registration and renewals for a variety of items requiring registration with an appropriate state or department agency. Specifically, a renewal and reminder system, apparatus and method for vehicle identification, license registration and renewal for a vehicle, is provided. More specifically, a system, apparatus and method is provided offering an electronic visual indicator system and apparatus for indicating information and registration status of a motorized vehicle, but may also be useful for any other items requiring a registration including, but not limited to, boats, aircraft, RVs, trailers, guns and fishing poles. Additionally, the present disclosure also relates to a mobile application software for renewing a license and registration using a portable or personal electronic device that may be connected to an appropriate government agency through the Internet.

To this end, an embodiment of the present invention includes a system for effecting notification of a license renewal. The system comprises, an object requiring license registration and renewal and an electronic visual indicator device contained on or incorporated within the object, wherein the electronic visual indicator device is configured for wirelessly receiving, storing and transmitting registration information pertaining to the object from a remote server.

In another embodiment of the present invention, an electronic visual device for providing identification and license registration for a vehicle, is provided. The device comprises housing, a plurality of LED lights positioned within the housing, a circuit board connected to and controlling the operation of the LED light strip, an independent power source and a wireless antenna or transponder for receiving a signal and data from a remote server or other electronic device, such as a personal electronic device. The electronic visual device can be retrofitted to an existing license plate, or provided as an OEM component from a manufacturer.

In another embodiment, the present electronic visual device further includes sensors including an impact/collision sensor and motion sensor. The device may further include a GPS antenna for providing a location of the associated vehicle, which can be sent to an agency or law enforcement database.

In yet another embodiment, a method for determining the registration status of a vehicle is provided. The method includes the steps of providing a visual indicator device on an existing license plate of a vehicle, transmitting information concerning the registration status of the vehicle from a remote database, receiving the information on the indicator device and displaying the appropriate signal on the device in response to the received information.

In still a further embodiment, a method of renewing license and registration information using a mobile application (app) installed on a personal electronic device, which connects through a data communication system to a database of an appropriate government agency, is provided. Data is transmitted the appropriate agency to the app, which sends the data to a visual indicator device located on a target object. The indicator device then displays the appropriate registration status of the object based on the received data.

It is, therefore, an advantage and objective of the present invention to provide an electronic visual indicator device that can be installed onto an existing license plate for a vehicle or offered as an OEM device on a new vehicle. The device provides up-to-date visual status of a vehicle's identification and registration.

It is yet another advantage and objective of the present invention to provide a paperless system and method for renewing and updating a vehicle registration by eliminating the printing of annual stickers and certification documents. A paperless system for renewals may likewise reduce the costs associated with traditional paper reminders, registrations and renewals.

Another advantage and objective of the present invention is to provide an electronic system and method for renewing and updating vehicle registration, which can be accomplished through a personal electronic device, including a personal computer, smartphone or tablet.

Yet another advantage and objective of the present invention is to provide a system, apparatus and method for renewing and updating vehicle registration while reducing the instances of potential fraud and theft associated with paper renewals.

Moreover, it is another advantage and objective of the present invention to provide a system and method for easily alerting law enforcement as to the registration status of a vehicle, as well as providing the ability to track a stolen vehicle, and/or a vehicle used during an illegal act.

Yet another advantage and objective of the present invention is to provide a system, apparatus that is operational independent from a vehicle operating and/or computer system.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of the electronic visual indicator device of the present disclosure positioned within a license plate on an automobile;

FIG. 2 illustrates a flowchart illustrating how the electronic visual indicator device of the present disclosure receives information concerning a specific vehicle from a registration system, such as a DMV; and,

FIG. 3 illustrates a flowchart for a method using mobile application software for renewing a license and registration.

### DETAILED DESCRIPTION

The present disclosure relates to a system, apparatus and method for an electronic visual indicator device for indicating the status of a license registration for an object requiring registration. For example, the present disclosure relates to an electronic visual indicator device for indicating the status of a license registration for a motorized vehicle, while providing a paperless option for renewal of the vehicle registration. The present system, apparatus and method may also be useful for any other item or object requiring a registration including, but not limited to, boats, ATVs, snowmobiles, aircraft, guns, fishing poles, hunting licenses, fishing licenses, vending machines, slot machines and other items. Therefore, and although registration and renewal of a vehicle license is described, it should be understood that the present system, apparatus and method is useful for nearly any item or object requiring a license and renewal of a license.

The present disclosure also relates to a method of renewing license and registration information using a mobile application software (“app”) for use on a mobile or personal electronic device connected through a data communication system to a database of an appropriate government agency (e.g., the Department of Motor Vehicles (DMV), Secretary of State, or the Department of Natural Resources (DNR)).

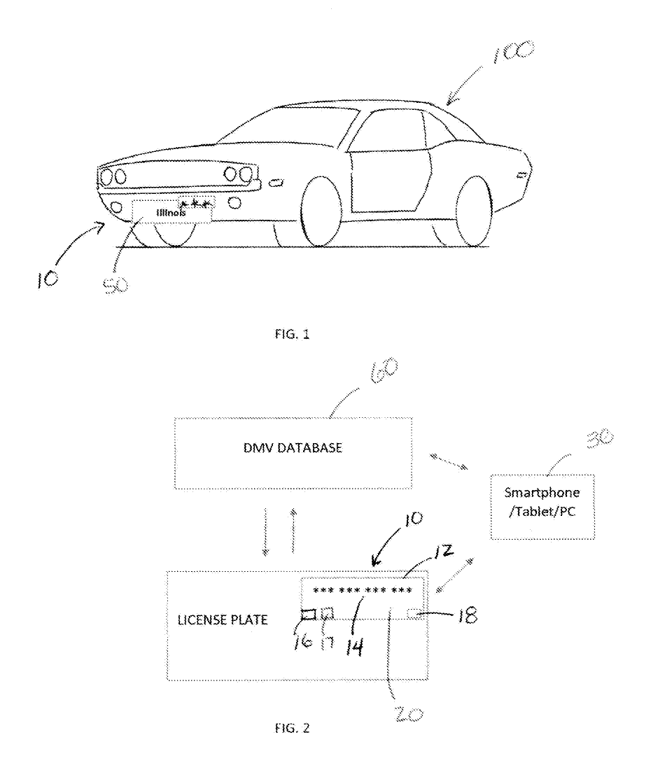

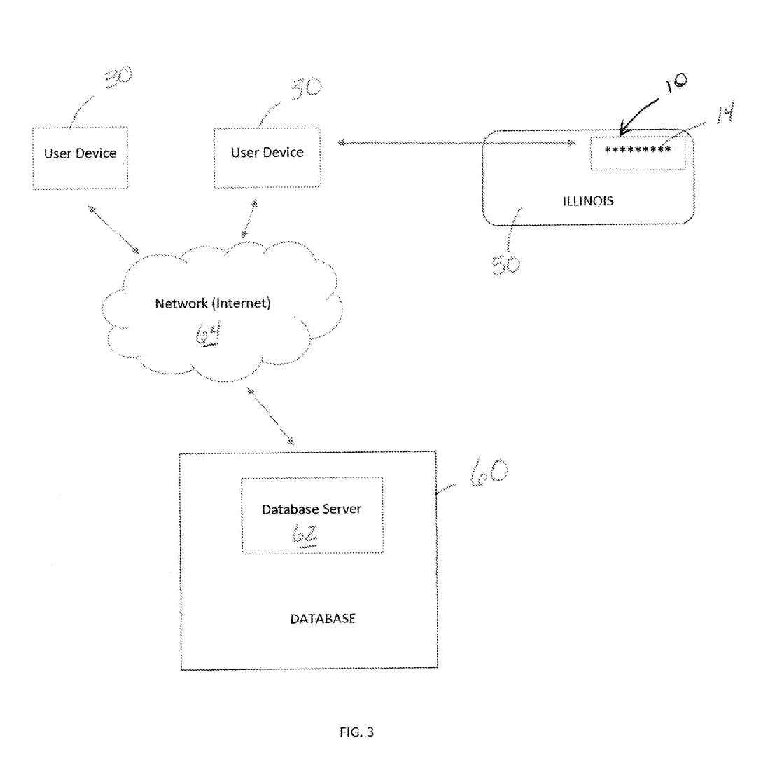

Now referring to the figures, wherein like numerals refer to like parts, FIGS. 1 and 2 illustrate an embodiment of the present electronic visual indicator system 10 of the present disclosure. FIG. 3 illustrates a flowchart for the mobile application software of the present disclosure.

As is commonly known, and shown in FIG. 1, a license plate 50 is traditionally a metal plate that is secured to a vehicle 100 and stamped with alpha numeric information that identifies the vehicle and signifies that the vehicle is properly registered with an appropriate government agency, such as the DMV or the Secretary of State. License plates 50 are required on all vehicles to indicate the ownership and legal registration of the vehicle. Although a car is shown, “vehicles” can include any form of motorized vehicle including passenger cars, motorcycles, personal and commercial trucks, boats, airplanes, RVs and motorhomes, ATVs, just to name a few. However, any item requiring a registration, including guns, fishing poles, vending machines, and slot machines may benefit from the present system, apparatus and method.

The present electronic visual indicator device 10, can be installed instead of or retrofitted into an existing license plate body 50. For example, the present device 10 may be installed in the area of the license plate 50 where the traditional registration sticker is placed. Optionally, the device 10 may be an OEM component installed at the factory and provided on a new car. It should be understood that while the device 10 can have any shape or size, it is generally small enough so as to avoid interfering with the alpha numeric information on the license plate body 50.

The components of the electronic visual indicator device 10 are contained within a sturdy housing 12. The housing body 12 can be constructed of any durable, weather-resistant material, such as a clear plastic, and may include a water-proof seal or coating. Preferably, the housing includes a clear cover, which enables the LED lights to be displayed through the housing. Optionally, the cover may be a display panel 20 (i.e., a liquid crystal display (LCD)) having a variety of colors, which are illuminated by the LED lights 14. The housing 12 can be built into an existing license plate body 50, or may even be located separate from a license plate and directly on a vehicle body, for example, a vehicle bumper. The second option of installing the device within a vehicle bumper would likely be an OEM component.

The components of the electronic visual indicator 10 contained within the housing 12 include at least one strip of LED lights 14, a printed circuit board or smart chip 16 connected to and operating the LED lights, a power source 17, and a wireless radio antenna or transponder 18, which receives and transmits registration and license information about the object from an agency (DMV or DNR) to the printed circuit board. Having its own long-term power source 17, such as a lithium battery, the electronic visual indicator device 10 operates independently from the computer module and power systems of the vehicle it is attached to. Thus, the present device 10 can be used on vehicles or items that may not have a power source (or the power source is turned off), enabling the device to be operational on an object even when its power source is turned off. Optionally, the device 10 may be hard-wired through a vehicle operating system and on-board computer (not shown), such that the information received concerning registration of the vehicle may be directed directly from the vehicle computer to the present device 10.

The present device 10 further includes at least one strip of light emitting diodes (LED, which are contained within the housing 12. The LED lights 14 may be arranged behind a front display panel (i.e., a liquid crystal display (LCD)) having a variety of colors. Alternatively, the LED lights 14 may themselves be provided in groups representing a variety of colors.

Registration data from an appropriate agency is transmitted to the device 10 through the wireless antenna or transponder 18, which is then transmitted to the printed circuit board 16. When activated by the printed circuit board or a smart chip 16, the lights 14 shine through the display panel 20, thereby lighting the appropriate color based on the situation, as will be described below. Alternatively, a specific color group of LED lights 14 could be activated depending on the situation. LED lights are advantageous in the present application because they have a very long life-span, up to about 20 years, and are very cost-effective. The LED light display 14 used in the present application would be visible even in extreme conditions; for example, its electric luminescent characteristic would make it visible even in intense sunlight. In adverse weather conditions, including rain, snow and ice the heat generated by the LED display maintains visibility of the display 20.

LED lights 14 can come in a variety of colors, which is advantageous to the present application. In particular, the different colors of LED lights 14 indicate the registration status of a vehicle. For example, a green light on the display indicates the electronic visual indicator device 10 is activated and the vehicle registration is in good standing. A yellow light on the display indicates there is a 30 day notice/warning that the registration is ready for renewal, and that the renewal should be completed within the next 30 days to change the display back to green. A red light on the display indicates that the license and registration is out of date, or expired. Again, until the registration is properly renewed, the light will remain red. Optionally, the light may blink on and off if it reaches the red stage. It should be understood that these are examples of light colors; however, the actual colors used and their respective meanings may depend on requirements set by the appropriate agency.

It should also be understood that any number of colors of LED lights can be incorporated into the present system and device, and also the assignment of colors and their particular meanings can change. For example, if a vehicle is reported stolen or missing, or is involved in illegal activity, such as a robbery, or even a potential Amber Alert, the appropriate signal can be send to the electronic visual indicator device 10. The lights on the device 10 would then be activated to a specific color, recognizable by law enforcement, and/or blink on and off. Using the present electronic visual indicator system and device 10, which provides a visible indicator through the plurality of LED lights 14, would greatly aid law enforcement in recovering stolen vehicles, and apprehending criminals. Additionally, different colored lights could be used to indicate a permanent or temporary disability or handicap, or even that a student driver is behind the wheel.

The present electronic visual indicator device 10 and system may also include a variety of additional features. For example, sensors may be used to indicate an impact/collision with another vehicle, and/or a motion sensor can be incorporated, which would indicate a vehicle is stolen. The device 10 may further include a GPS antenna for providing a location of the associated vehicle, which can be sent to an agency or law enforcement database, as necessary.

FIG. 2 represents a method of activating the present electronic visual indicator device 10. During activation, the present device 10 receives a signal through the wireless antenna or transponder 18. The initial signal may originate from a database 60 at the DMV and be transmitted from a server 62 directly to the device 10. For example, the customer may visit a DMV location, or renew and pay a registration fee through the DMV website. After receiving the appropriate information and required payment, the DMV database 60 through its server 62 may communicate directly with the device 10 on the vehicle and activate the appropriate lights 14 on the device.

Alternatively, the owner of the vehicle may receive an electronic reminder through his/her own personal and/or portable electronic device 30, including a personal computer, laptop computer, smartphone or tablet that his/her vehicle is due for renewal and/or registration. Once the vehicle owner pays the required registration or renewal fee, a transmission can be sent from the DMV database 60 to the owner's personal electronic device 30. The owner, through his/her smartphone, tablet, or other personal electronic device 30 then sends a transmission to activate the circuit board or chip within the device 10, thereby activating the appropriate color of LED lights 14. As noted, this electronic process, whether through the DMV or other agency computer, or through the vehicle owner's electronic device, significantly reduces the time, money and effort previously required for paper processing, while providing a more accurate and efficient system. State agencies would likely benefit in time and overhead costs from this streamlined system, device and method. Additionally, law enforcement would benefit from the highly visible indicators, enabling officers to quickly assess the status of vehicle.

Referring now to FIG. 3, there is illustrated a flow chart for a system and method of renewing a license or registration using a software application (app). The software app would be loaded onto the personal and/or portable electronic device 30 of the owner or user, including a personal computer, laptop computer, smartphone or tablet. Through the app, the owner may receive an electronic reminder, generated from the appropriate agency, through his/her device that a vehicle or object registration is due for renewal. The owner can then access the database 60 of the appropriate agency over the Internet 64 for specific information relating to the specific vehicle or license needing renewal. The owner is then able to pay the required registration or renewal fee, either in person, or online, after which a transmission can be sent from the agency database 60 through its server 62 to the owner's personal electronic device 30. The owner, through his/her personal electronic device 30 then sends a transmission to activate the visual indicator device 10, thereby activating the appropriate color of LED lights 14 as previously described.

Although the focus of the present disclosure is use of the present electronic visual indicator system 10 in connection with motor vehicles such as cars, trucks and motorcycles, it is anticipated that the present system, apparatus and method may be useful for other vehicles, items and objects requiring registration. For example, it may be feasible to add an indicator device 10 into the barrel of a gun. The light display may show that the gun is properly registered. Additionally, the light display may change to show an unregistered status or registration to a different owner. Similarly, a visual indicator device may be embedded into a fishing or hunting license. Again, a visual light display would indicate the status of the license, advising on timing for renewal or whether the license is valid or expired. Similarly, the present visual indicator device 10 would be useful for vending machines and slot machines, so effecting cost-efficient registrations and renewal of licenses, as needed.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

1. A system for effecting notification of a license renewal, the system comprising:
an object requiring license registration and renewal; and,
an electronic visual indicator device contained on or incorporated within the object, wherein the electronic visual indicator device is configured for wirelessly receiving, storing and transmitting registration information pertaining to the object from a remote server.

2. The system of claim 1, wherein the electronic visual indicator device further comprises:
a weather-resistant housing;
at least one strip of LED lights positioned within the housing for visual notification;
a printed circuit board connected to and operating the LED lights;
a power source independent of a power source incorporated in the object; and,
a wireless transponder for receiving and transmitting registration information about the object to the printed circuit board.

3. The system of claim 2 wherein the LED lights are configured for visually indicating a status of the registration information pertaining to the object.

4. The system of claim 3, wherein the LED lights are capable of changing color depending on the status of the registration information pertaining to the object.

5. The system of claim 2, wherein the electronic visual indicator device further includes a display panel positioned in front of the LED lights, the display panel configured to visually indicating a status of the registration information pertaining to the object.

6. The system of claim 2, wherein the power source includes a lithium battery.

7. The system of claim 1, the system further including a software application loaded onto a personal electronic device, the software application capable of transmitting information relating to the registration status of the object to the electronic visual indicator device from a remote server through use of a personal electronic device.

8. The system of claim 7 wherein the registration status of the object can be changed using the software application on the personal electronic device.

9. The system of claim 7 wherein the personal electronic device is selected from the group consisting of a personal computer, a smartphone and a tablet.

10. The system of claim 1, wherein the object is selected from the group consisting of a motorized vehicles, non-motorized vehicles, hunting and fishing licenses, guns, fishing poles, vending machines, and slot machines.

11. A method for affecting the license registration status of an object, the method comprising the steps of:
providing a visual indicator device on an object;
transmitting data concerning the registration status of the object from a remote database;
receiving and downloading the data from the remote database on the indicator device, and;
displaying an appropriate visual signal on the device in response to the received data.

12. The method of claim 11 wherein the method further includes the steps of providing a personal electronic device, and downloading the personal electronic device with a software application.

13. The method of claim 12 wherein the software application is capable of communicating data between the personal electronic device and the remote database.

14. The method of claim 12 wherein the method further includes the step of transmitting the data from the personal electronic device to the visual indicator device on the object.

15. The method of claim 11, wherein the method further includes the step of renewing a registration as indicated by the appropriate visual signal on the device.

16. An electronic visual indicator device for identifying the license registration status of an object, the device comprising:
a weather-resistant housing;
a plurality of lights positioned within the housing for visual notification;
a smart card connected to and operating the LED lights the smart card adapted for receiving, storing and transmitting data relating to registration status;
a power source;
a wireless transponder for receiving and transmitting the registration data about the object to the smart card for activation of the plurality of lights corresponding to the registration status of the object.

17. The electronic visual indicator device of claim 16, wherein the plurality of lights are LED lights.

18. The electronic visual indicator device of claim 16 wherein the power source is independent of a power source associated with the object.

19. The electronic visual indicator device of claim 16 wherein the transponder is capable of receiving data from a personal electronic device loaded with a software application capable of receiving and transmitting data between a server and the personal electronic device.

20. (canceled)
